(19) United States
(12) Patent Application Publication
(10) Pub. No.: US 2026/0142428 A1
(43) Pub. Date: May 21, 2026

(54) TERMINAL

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Liping KANG, Mie (JP); Shuhei SATO, Mie (JP)

(21) Appl. No.: 19/391,000

(22) Filed: Nov. 17, 2025

(30) Foreign Application Priority Data
Nov. 18, 2024 (JP) 2024-200199

(51) Int. Cl. H01R 24/40; H01R 103/00

(52) U.S. Cl. CPC H01R 24/40; H01R 2103/00

(57) ABSTRACT

An outer conductor used as a main body includes a spring portion, a rear portion, and a bulging portion. The bulging portion has a shape that is formed by a front-rear part being bulged radially outward, the front-rear part being a part that extends from a root portion of the spring portion to the rear portion. An end surface of the bulging portion at a leading end of the bulging portion in a bulging direction of the bulging portion includes a front end top portion that is located on the root portion side and a rear end top portion that is located on the rear portion side.

### CROSS-REFERENCE TO RELATED APPLICATIONS

This application is based on and claims priority from Japanese Patent Application No. 2024-200199, filed on Nov. 18, 2024, with the Japan Patent Office, the disclosure of which is incorporated herein in its entirety by reference.

### TECHNICAL FIELD

The present disclosure relates to a terminal.

### BACKGROUND

JP 2022-069162 A discloses a female shield assembly that includes a female inner terminal, a female inner housing, and a female shield outer terminal. The female shield assembly is connected to a cable terminal. The female shield outer terminal includes a front cylindrical connecting portion whose axis is oriented in a front-rear direction and that has a cylindrical shape. In the front cylindrical connecting portion, an elastically deformable contact piece is formed through slitting and bending. The contact piece comes into contact with a mating male shield outer terminal that is fitted to a radially outer side of the front cylindrical connecting portion. As a result of the contact piece coming into contact with the male shield outer terminal, the female shield outer terminal is electrically connected to the male shield outer terminal.

### SUMMARY

If the contact piece has an insufficient elastic force (spring reaction force), the stability of the connection between the female shield outer terminal and the male shield outer terminal is impaired. To address this, by providing a reinforcing structure to the front cylindrical connecting portion, the elastic force of the contact piece can be adjusted to be capable of ensuring the connection stability. For example, a bulging portion that is formed by bulging radially outward a part of the front cylindrical connecting portion that extends from a root portion of the contact piece to a rear thereof can be used as the reinforcing structure. However, when the bulging portion is provided to the front cylindrical connecting portion as the reinforcing structure, the bulging portion comes into contact with the mating male shield outer terminal that is fitted to an outer circumference of the front cylindrical connecting portion, which may cause problems such as an increase in the connection resistance and damage to the male shield outer terminal. As a result, the stability of the connection between the female shield outer terminal and the male shield outer terminal may be impaired on the contrary.

Accordingly, it is an object of the present disclosure to provide a terminal that can ensure connection stability even when a bulging portion is provided.

A terminal according to the present disclosure is a terminal including: a tubular main body whose axis is oriented in a front-rear direction, wherein the main body includes: a fulcrum; a spring portion that extends in the front-rear direction and is elastically deformable about the fulcrum; a contact point that has a shape that is formed by a portion of the spring portion being bulged radially outward; a rear portion that is located on an opposite side of the spring portion in the front-rear direction at a position rearward of the fulcrum; and a bulging portion that has a shape that is formed by a front-rear part being bulged radially outward, the front-rear part being a part that extends from a root portion of the spring portion on the fulcrum side to the rear portion, and the bulging portion includes an end surface at a leading end of the front-rear part in a bulging direction of the front-rear part, the end surface includes: a front end top portion that is located at a radially outermost position on the root portion side; and a rear end top portion that is located at a radially outermost position on the rear portion side, and as viewed in a cross section of the bulging portion taken along the axis, a normal line that connects the front end top portion and a front reference line that extends along a front adjacent part that is adjacent to the bulging portion in the root portion is shorter in length than a normal line that connects the rear end top portion and a rear reference line that extends along a rear adjacent part that is adjacent to the bulging portion in the rear portion.

According to the present disclosure, it is possible to provide a terminal that can ensure connection stability even when a bulging portion is provided.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a perspective view of a terminal according to Embodiment 1 as viewed from the front diagonally above.

FIG. 2 is a perspective view of the terminal according to Embodiment 1 as viewed from the front diagonally below.

FIG. 3 is a side cross-sectional view of the terminal according to Embodiment 1.

FIG. 4 is an enlarged plan view of a spring portion that is included in the terminal according to Embodiment 1.

FIG. 5 is an enlarged side cross-sectional view of a bulging portion that is included in the terminal according to Embodiment 1.

FIG. 6 is an enlarged side cross-sectional view of a front end side of the bulging portion of the terminal according to Embodiment 1.

FIG. 7 is an enlarged side cross-sectional view of a rear end side of the bulging portion of the terminal according to Embodiment 1.

FIG. 8 is a side cross-sectional view of the terminal according to Embodiment 1 in a state in which it is connected to a mating terminal.

### DETAILED DESCRIPTION

In the following detailed description, reference is made to the accompanying drawings, which form a part hereof. The illustrative embodiments described in the detailed description, drawings, and claims are not meant to be limiting. Other embodiments may be utilized, and other changes may be made, without departing from the spirit or scope of the subject matter presented here.

### Description of Embodiment of the Present Disclosure

First, aspects of an embodiment according to the present disclosure will be listed and described.
(1) A terminal according to the present disclosure is a terminal including: a tubular main body whose axis is oriented in a front-rear direction, wherein the main body includes: a fulcrum; a spring portion that extends in the front-rear direction and is elastically deformable about the fulcrum; a contact point that has a shape that is formed by a portion of the spring portion being bulged radially outward; a rear portion that is located on an opposite side of the spring portion in the front-rear direction at a position rearward of the fulcrum; and a bulging portion that has a shape that is formed by a front-rear part being bulged radially outward, the front-rear part being a part that extends from a root portion of the spring portion on the fulcrum side to the rear portion, and the bulging portion includes an end surface at a leading end of the front-rear part in a bulging direction of the front-rear part, the end surface includes: a front end top portion that is located at a radially outermost position on the root portion side; and a rear end top portion that is located at a radially outermost position on the rear portion side, and as viewed in a cross section of the bulging portion taken along the axis, a normal line that connects the front end top portion and a front reference line that extends along a front adjacent part that is adjacent to the bulging portion in the root portion is shorter in length than a normal line that connects the rear end top portion and a rear reference line that extends along a rear adjacent part that is adjacent to the bulging portion in the rear portion.

With the configuration according to clause (1), the bulging amount of the front end top portion that bulges radially outward can be kept small, and it is therefore possible to avoid a situation in which the front end top portion comes into contact with a mating terminal in a state in which the mating terminal is fitted to a radially outer side of the main body. Accordingly, it is possible to prevent an increase in the connection resistance, damage, the like caused by an interference of the mating terminal with the bulging portion, and it is therefore possible to ensure the connection stability when the terminal is connected to the mating terminal. On the other hand, the bulging amount of the rear end top portion that bulges radially outward can be increased, and it is therefore possible to adjust the spring reaction force of the spring portion to a predetermined level.
(2) In the terminal according to clause (1), it is preferable that, in a state in which the contact point is in contact with a mating terminal that is fitted to a radially outer side of the main body, the front end top portion is spaced apart from the mating terminal.

With the configuration according to clause (2), the front end top portion does not come into contact with the mating terminal, and thus damage and the like caused by an interference of the mating terminal with the bulging portion does not occur. Accordingly, the connection stability can be more reliably ensured.
(3) In the terminal according to clause (1) or (2), it is preferable that a front end surface of the bulging portion is configured as a front slope portion that is inclined forward from the front end top portion to the front adjacent part, a rear end surface of the bulging portion is configured as a rear slope portion that is inclined rearward from the rear end top portion to the rear adjacent part, and the rear slope portion is longer in an inclination direction than the front slope portion.

With the configuration according to clause (3), the bulging amount of the front end top portion can be sufficiently kept small, and thus the interference between the front end top portion and the mating terminal can be more likely to be avoided. Also, the rear end portion of the bulging portion including the rear end top portion and the rear slope portion can be shaped with high accuracy.
(4) In the terminal according to any one of clauses (1) to (3), it is preferable that the spring portion includes: a fold that extends circumferentially at an intermediate position of the bulging portion in the front-rear direction; an inclined portion that is located on a front side of front and rear sides of the fold and inclined radially outward as it extends forward; and a horizontal portion that is located on the rear side and arranged along the front-rear direction.

With the configuration according to clause (4), the front end top portion is located above the slope of the inclined portion, which makes it more likely that the front end top portion comes into contact with the mating terminal. Accordingly, the bulging amount of the front end top portion that bulges radially outward can be kept small, and the use of the configuration of the present disclosure that avoids the interference between the front end top portion and the mating terminal provides significant benefits. Also, the bulging portion is provided in a part that extends the inclined portion to the horizontal portion, and thus the function of reinforcing the spring portion can be appropriately exhibited.
(5) It is preferable that the terminal according to any one of clauses (1) to (4) includes: an inner conductor; a dielectric that houses the inner conductor; and an outer conductor that houses the dielectric, and the outer conductor is used as the main body.

With the configuration according to clause (5), it is possible to avoid a situation in which the front end top portion comes into contact with a mating outer conductor, and ensure the stability of the connection between the outer conductor and the mating outer conductor. Accordingly, it is possible to exhibit a predetermined shielding performance.

### Detailed Description of Embodiment of the Present Disclosure

A specific example of the present disclosure will be described below with reference to the drawings. It is to be noted that the present invention is not limited to the example given below, the scope of the present disclosure is indicated by the appended claims, and all changes that come within the meaning and range of equivalency of the claims are intended to be embraced therein.

### Embodiment 1

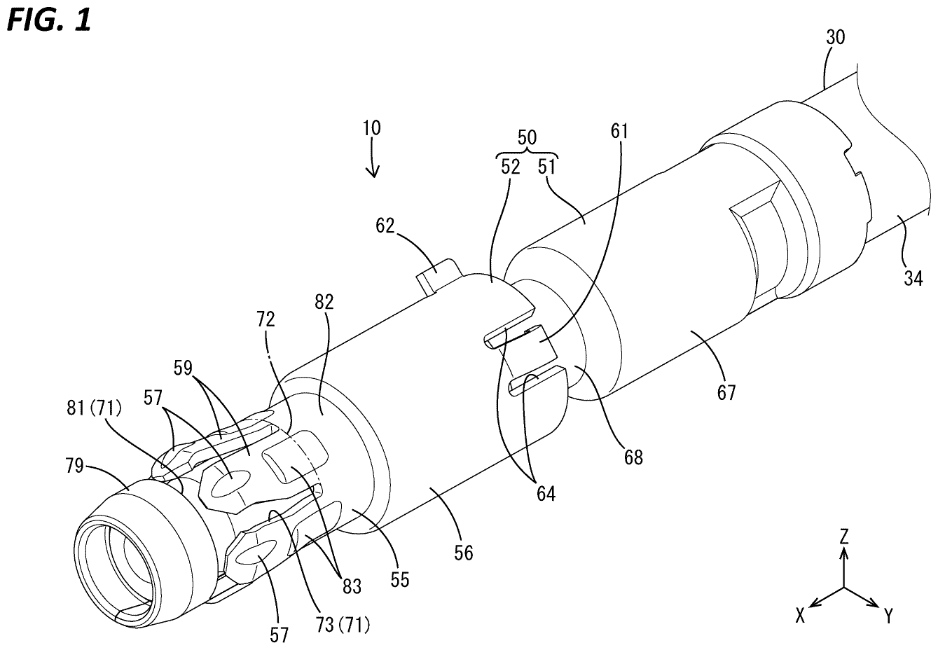

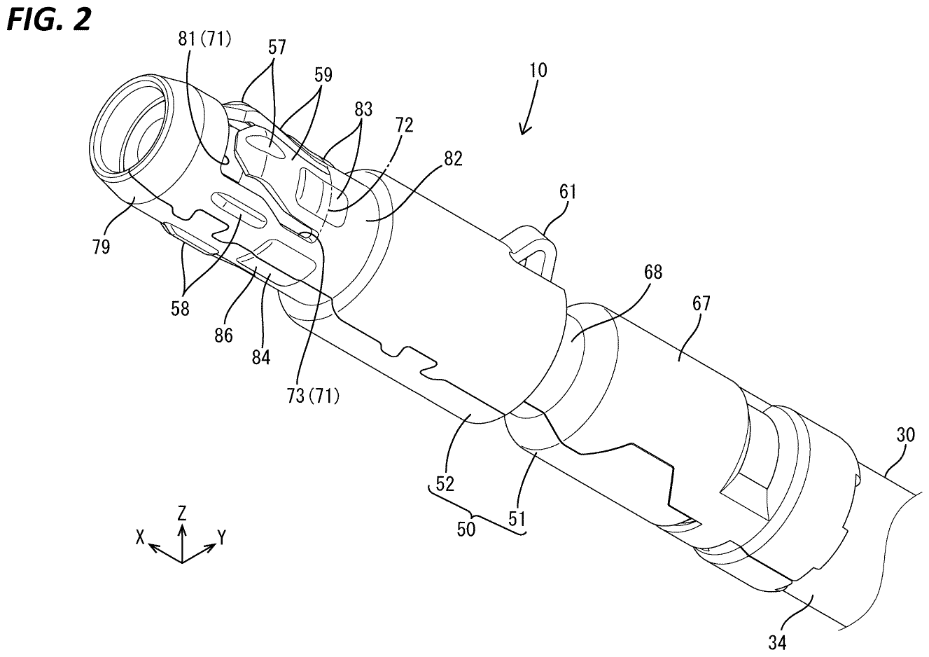

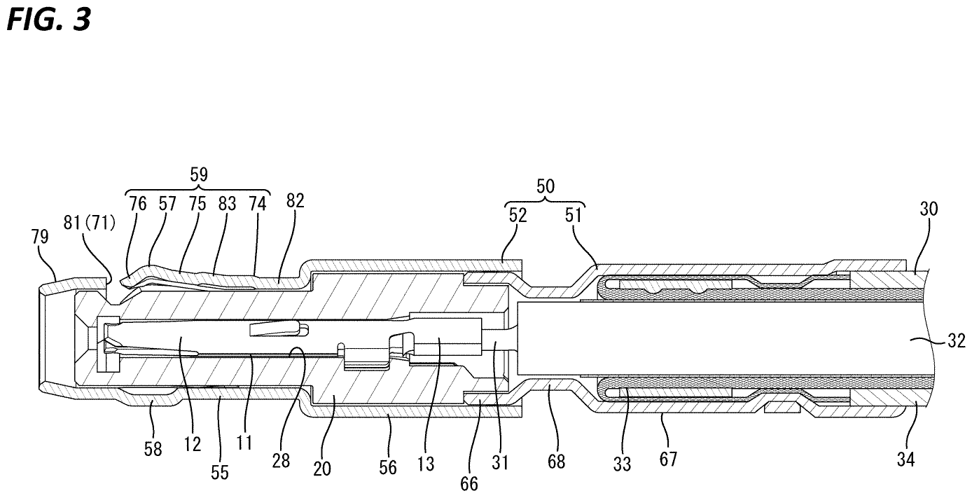

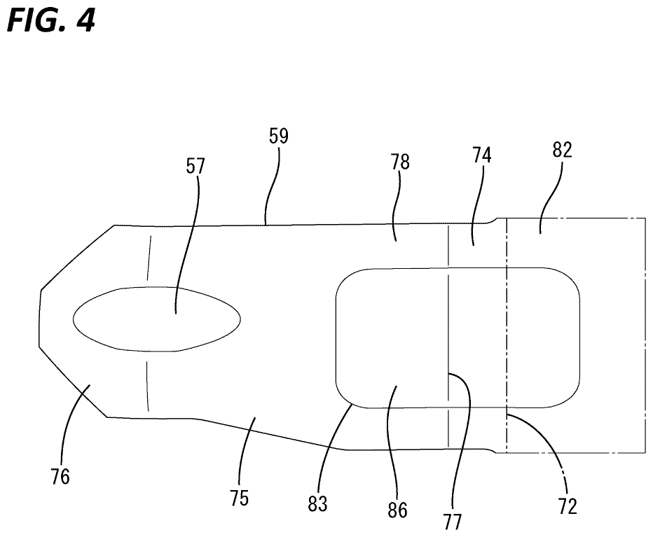

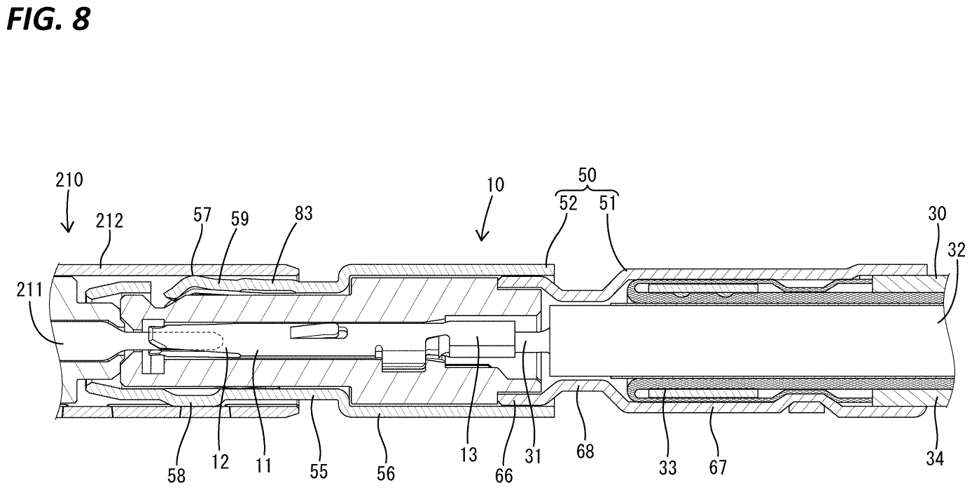

A terminal 10 according to Embodiment 1 is a so-called shield terminal, and is connected to an end portion of a shielded electric wire 30 as shown in FIGS. 1 to 3. As shown in FIG. 3, the terminal 10 includes an inner conductor 11, a dielectric 20 that houses the inner conductor 11, and an outer conductor 50 that houses the dielectric 20. The terminal 10 has an elongated shape that extends in an axial direction thereof as a whole. The terminal 10 is housed in a housing of a connector (not shown). As a result of the connector being fitted to a mating connector (not shown), the terminal 10 is electrically connected to a mating terminal 210 of the mating connector (see FIG. 8). In the following description, the term “front-rear direction” corresponds to the axial direction. The term “front” corresponds to the front in a direction in which the connector is fitted to the mating connector. The term “up-down direction” is based on the vertical direction of the diagrams excluding FIG. 4. The up-down direction is also referred to as “radial direction”. The radial direction corresponds to a radial direction of the outer conductor 50. In FIGS. 1 and 2, reference signs X, Y, and Z indicate the front direction, the right direction, and the upper direction, respectively. These directions are defined for the sake of convenience, and thus for example, the term “lower” does not necessarily mean downward in the direction of gravity.

### Inner Conductor

The inner conductor 11 is formed by subjecting a conductive metal plate to bending processing or the like. As shown in FIG. 3, the inner conductor 11 includes a tubular connecting portion 12 and a crimp portion 13 that is provided behind the connecting portion 12 and continuous to the connecting portion 12. As shown in FIG. 8, the connecting portion 12 is connected to a mating inner conductor 211 by receiving the mating inner conductor 211. The crimp portion 13 is connected, through crimping, to a conductor 31, such as a core wire, that is provided at the end portion of the shielded electric wire 30. The shielded electric wire 30 is a so-called co-axial wire, and includes an insulating coating 32 that surrounds an outer circumference of the conductor 31, a cylindrical mesh braided wire 33 that surrounds an outer circumference of the coating 32, and an insulating sheath 34 that surrounds an outer circumference of the braided wire 33. The conductor 31 has a function of transmitting high-frequency signals. The braided wire 33 has a function of shielding electromagnetic waves.

### Dielectric

The dielectric 20 is made of a synthetic resin, and has a cylindrical shape as a whole. As shown in FIG. 3, the dielectric 20 includes a terminal receiving hole 28 that extends in the front-rear direction. The inner conductor 11 is inserted into the terminal receiving hole 28 from the rear and housed in the terminal receiving hole 28. The dielectric 20 maintains an insulated state between the inner conductor 11 and the outer conductor 50.

### Outer Conductor

The outer conductor 50 is formed by subjecting a conductive metal plate to bending processing or the like. The outer conductor 50 corresponds to the main body of the present disclosure. As shown in FIGS. 1 to 3, the outer conductor 50 includes a first outer conductor 51 and a second outer conductor 52 that are separate from each other. The first outer conductor 51 and the second outer conductor 52 have a cylindrical shape whose axis is oriented in the front-rear direction.

The first outer conductor 51 constitutes a rear portion of the outer conductor 50. The first outer conductor 51 includes a tubular connecting portion 66 that has a cylindrical shape, a tubular main body portion 67 that has a cylindrical shape and is provided behind the tubular connecting portion 66, and a narrow portion 68 that is provided between the tubular main body portion 67 and the tubular connecting portion 66 in the front-rear direction. The narrow portion 68 has a narrow shape whose diameter is reduced radially inward from a rear end of the tubular connecting portion 66 and a front end of the tubular main body portion 67. As shown in FIG. 3, the tubular main body portion 67 is connected, through crimping, to the braided wire 33 of the shielded electric wire 30.

The second outer conductor 52 constitutes a front portion of the outer conductor 50. The second outer conductor 52 surrounds an outer circumference of the dielectric 20. The second outer conductor 52 includes a small diameter portion 55 that is provided at the front and a large diameter portion 56 that is provided at the rear and has a diameter larger than the small diameter portion 55.

The tubular connecting portion 66 is coaxially fitted into a rear end portion of the large diameter portion 56. The rear end portion of the large diameter portion 56 and the tubular connecting portion 66 are joined to each other through welding such as spot welding. As shown in FIG. 1, a misinsertion preventing portion 61 and a rotation suppressing portion 62 are provided on an upper side of the rear end portion of the large diameter portion 56. The misinsertion preventing portion 61 is provided between a pair of slits 64 that are formed circumferentially in the rear end portion of the large diameter portion 56 so as to be bent radially outward into a mountain shape. When the terminal 10 is inserted into the housing of the connector while the terminal 10 is in an inappropriate insertion orientation in the circumferential direction, a front surface of the misinsertion preventing portion 61 abuts against an opposing surface such as a rear surface of the housing. With this configuration, it is possible to prevent the terminal 10 in an inappropriate orientation from being inserted into the housing.

The rotation suppressing portion 62 is shaped to protrude radially outward as a result of a portion of the rear end portion of the large diameter portion 56 being bent along a fold line that extends in the front-rear direction. The rotation suppressing portion 62 has a flat plate shape, and is provided with its plate surface facing toward the circumferential direction. The rotation suppressing portion 62 is inserted into a rotation suppressing groove (not shown) formed in the housing. With this configuration, it is possible to suppress the rotation of the terminal 10 about the axis in the housing.

As shown in FIGS. 1 and 2, the small diameter portion 55 includes a plurality of contact points 57 and a plurality of fixed contact points 58 (not shown in FIG. 1). The contact points 57 and the fixed contact points 58 are circumferentially arranged in the small diameter portion 55. The contact points 57 are configured so as to be capable of changing their positions in the radial direction. The fixed contact points 58 are fixed in the small diameter portion 55 so as not to be capable of changing their positions in the radial direction. As shown in FIG. 2, the fixed contact points 58 are provided in a pair in a lower portion of the small diameter portion 55. Each of the fixed contact points 58 bulges out in the shape of a rib that radially bulges outward and extends in the front-rear direction as a result of a portion of the small diameter portion 55 being hammered out from radially inside through press processing.

As shown in FIGS. 1 and 2, the contact points 57 are provided in elastically deformable spring portions 59 that are portions of the small diameter portion 55. Four spring portions 59 are circumferentially arranged in the small diameter portion 55 excluding the lower portion of the small diameter portion 55. The contact points 57 are provided separately in the spring portions 59, respectively. As shown in FIG. 8, a cylindrical mating outer conductor 212 of the mating terminal 210 is fitted onto the small diameter portion 55. The contact point 57 and the fixed contact point 58 come into contact with the mating outer conductor 212 from radially inside. With this configuration, the outer conductor 50 is electrically connected to the mating outer conductor 212.

As shown in FIGS. 1 and 2, each of the spring portions 59 is formed as a result of a portion of the small diameter portion 55 being slit and bent. In the case of Embodiment 1, four spring portions 59 are independently arranged circumferentially inside of gate-shaped notches 71 that are formed in the small diameter portion 55.

Each of the spring portions 59 has a shape that protrudes in the shape of a cantilever from a fulcrum 72 toward the front at an intermediate position (a middle position) of the small diameter portion 55 in the front-rear direction. Each of the spring portions 59 is elastically deformable in the radial direction about the fulcrum 72. The fulcrum 72 is formed to extend along the circumferential direction at a front-rear position that corresponds to a position of rear ends of front-rear slits 73 of the notches 71.

As shown in FIG. 3, each of the spring portions 59 includes a short horizontal portion 74 that extends from the fulcrum 72 toward the front along the front-rear direction, an inclined portion 75 that extends inclined radially outward from a front end of the horizontal portion 74 toward the front, and a short leading end portion 76 that extends inclined radially inward from a front end (a front end top portion 88, which will be described later) of the inclined portion 75 toward a front end (a leading end). As shown in FIG. 4, a fold 77 that extends circumferentially is formed between a front end of the horizontal portion 74 and a rear end of the inclined portion 75. In the spring portion 59, a portion that extends from a rear half portion of the inclined portion 75 to the horizontal portion 74 is configured as a root portion 78 that is located on the fulcrum 72 side.

The inclined portion 75 is configured such that its width dimension in the circumferential direction gradually decreases from the fulcrum 72 toward the front. In the spring portion 59, the contact point 57 is formed to have an embossed shape that bulges radially outward at a top portion that extends from the inclined portion 75 to the leading end portion 76. As shown in FIG. 3, the contact point 57 is a portion that is located at a radially outermost position in the spring portion 59. A front end portion of the small diameter portion 55 is configured as a cylindrical protection portion 79 that is located forward of the spring portion 59. With the protection portion 79, a front end slit 81 of the notch 71 is defined to extend along the circumferential direction.

A rear end portion of the small diameter portion 55 is configured as a cylindrical rear portion 82 that is located rearward of the spring portion 59. As shown in FIG. 4, the rear portion 82 is provided on the opposite side of the root portion 78 in the front-rear direction across the fulcrum 72.

As shown in FIGS. 1 and 2, the small diameter portion 55 includes a plurality of bulging portions 83 and one fixed bulging portion 84 (not shown in FIG. 1) that are arranged spaced apart from each other in the circumferential direction. The bulging portions 83 and the fixed bulging portion 84 bulge radially outward as a result of a front-rear part (indicated by reference numerals 83 and 84) that is a portion of the small diameter portion 55 being hammered out from radially inside through press processing. In the small diameter portion 55, the front-rear slits 73 of the notches 71 are arranged spaced apart from each other in the circumferential direction, and each of the bulging portions 83 and the fixed bulging portion 84 is provided in a part between adjacent front-rear slits 73 in the circumferential direction.

As shown in FIG. 2, the fixed bulging portion 84 is provided rearward of the fixed contact points 58. The fixed bulging portion 84 is fixedly provided in the small diameter portion 55 so as not to be capable of changing its position in the radial direction. The bulging portions 83 are provided rearward of the contact points 57. As will be described later, due to each of the bulging portions 83 partially extending to the root portion 78 of the spring portion 59, the bulging portions 83 are provided in the small diameter portion 55 so as to be capable of changing their positions in the radial direction. As shown in FIG. 4, as viewed from the front-rear direction, the center of the bulging portion 83 in the circumferential direction is offset from the center of the contact point 57 in the circumferential direction.

Each of the bulging portions 83 and the fixed bulging portion 84 includes an end surface 86 that slightly rises radially outward with respect to a circumferential surface of the front-rear part of the small diameter portion 55. When each of the bulging portions 83 and the fixed bulging portion 84 is viewed from radially outside, as shown in FIG. 4, the end surface 86 has a rectangular outer shape whose four corners are rounded. Due to the end surface 86, each of the bulging portions 83 and the fixed bulging portion 84 has a flat mat-like shape. The end surface 86 of the fixed bulging portion 84 is provided to extend along the front-rear direction and the circumferential direction as a whole.

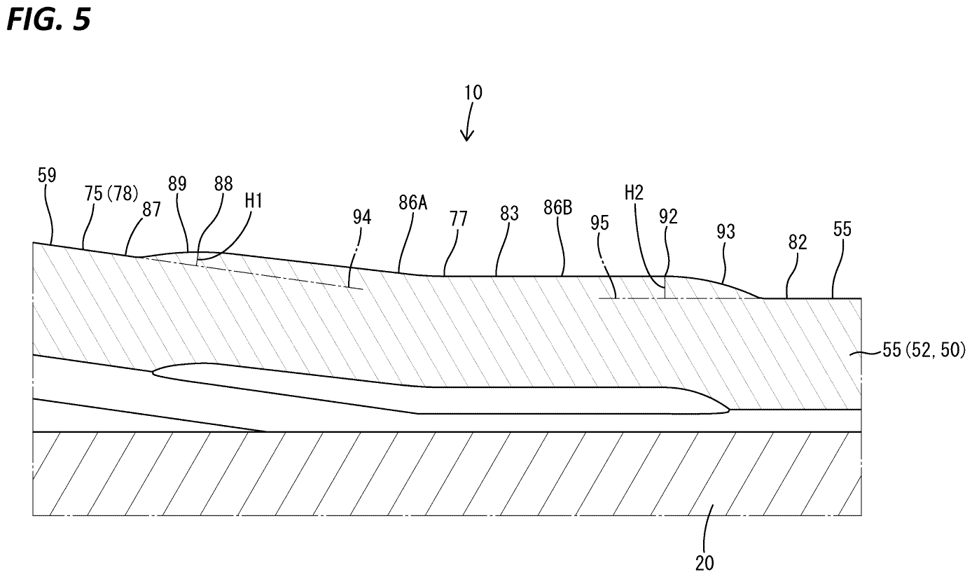

As shown in FIG. 4, the bulging portion 83 is formed in a front-rear part that extends from the root portion 78 to the rear portion 82 in the front-rear direction. A rear end portion of the bulging portion 83 is provided in the rear portion 82. A part of the bulging portion 83 excluding the rear end portion is provided in the root portion 78. The bulging portion 83 includes the fold 77 that extends circumferentially at a middle position of the bulging portion 83 in the front-rear direction. As shown in FIG. 5, an end surface 86A of a front half portion of the bulging portion 83 is provided to extend inclined radially outward from the fold 77 toward the front along the inclined portion 75. An end surface 86B of a rear half portion of the bulging portion 83 is provided to extend from the fold 77 toward the rear in the front-rear direction.

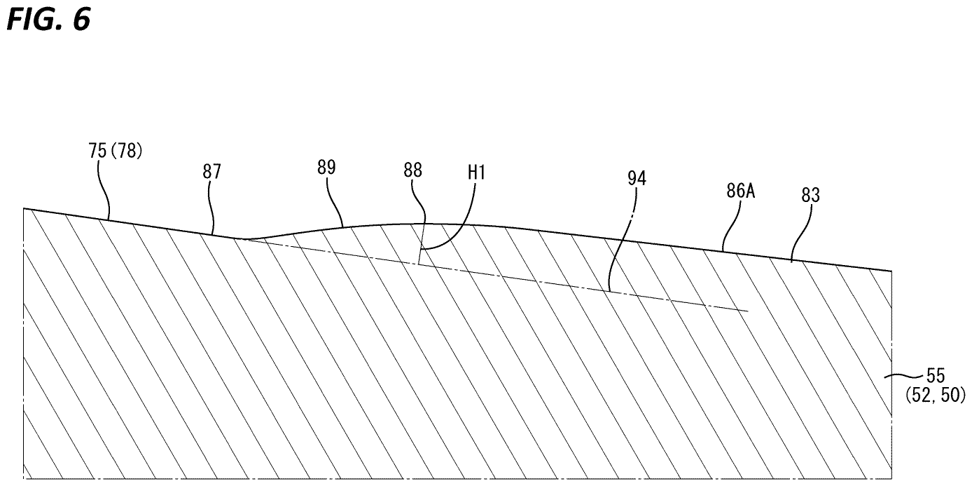

As shown in FIGS. 5 and 6, in a cross-sectional view (hereinafter referred to as “side cross-sectional view”) of the small diameter portion 55 taken along the front-rear direction at an intermediate position (any middle position) of the bulging portion 83 in the circumferential direction, a part that is located forward of the bulging portion 83 in the root portion 78 and adjacent to the bulging portion 83 is configured as a front adjacent part 87 that extends along an inclination direction of the inclined portion 75. In the side cross-sectional view, a front end part of the end surface 86A of the front half portion of the bulging portion 83 is configured as a front end top portion 88 that is located at a radially outermost position in the end surface 86 of the bulging portion 83 on the root portion 78 side. In the side cross-sectional view, a portion between the front end top portion 88 and the front adjacent part 87 is configured as a curved front slope portion 89 that is inclined forward from the front end top portion 88 to the front adjacent part 87. The front adjacent part 87, the front end top portion 88, and the front slope portion 89 are provided continuously in the circumferential direction.

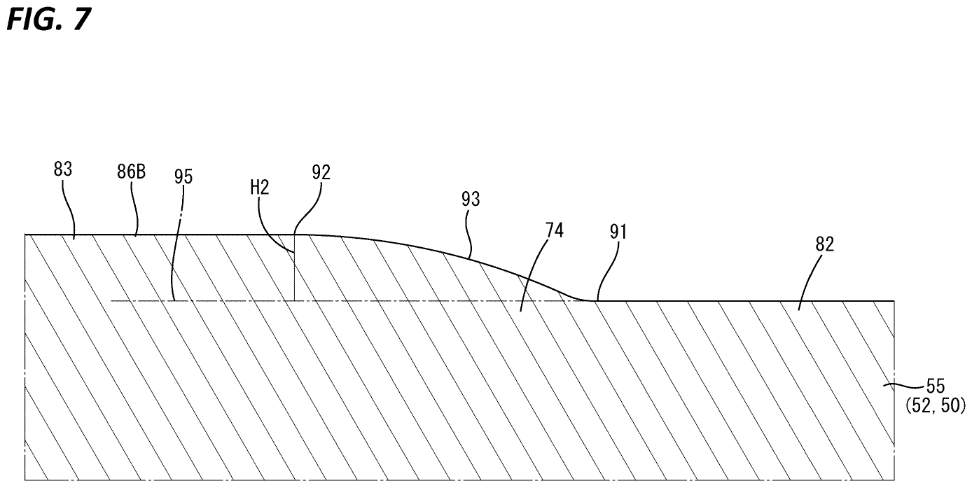

As shown in FIGS. 5 and 7, in the side cross-sectional view, a part of the rear portion 82 that is adjacent to the bulging portion 83 at a position rearward of the bulging portion 83 is configured as a rear adjacent part 91 that extends along the front-rear direction. In the side cross-sectional view, a rear end part of the end surface 86B of the rear half portion of the bulging portion 83 is configured as a rear end top portion 92 that is located at a radially outermost position in the end surface 86 of the bulging portion 83 on the horizontal portion 74 side and the rear portion 82 side. In the side cross-sectional view, a portion between the rear end top portion 92 and the rear adjacent part 91 is configured as a curved rear slope portion 93 that is inclined rearward from the rear end top portion 92 to the rear adjacent part 91. The rear slope portion 93 is longer in the inclination direction than the front slope portion 89. The rear adjacent part 91, the rear end top portion 92, and the rear slope portion 93 are provided continuously in the circumferential direction.

As shown in FIGS. 5 to 7, in the side cross-sectional view, where an imaginary line that is an extension of the front adjacent part 87 that extends rearward along the inclination direction is defined as a front reference line 94, and an imaginary line that is an extension of the rear adjacent part 91 that extends forward along the front-rear direction is defined as a rear reference line 95, a normal line H1 that extends downward from the front end top portion 88 to the front reference line 94 is smaller (shorter) in length (height) than a normal line H2 that extends downward from the rear end top portion 92 to the rear reference line 95. In short, the bulging amount of the front end top portion 88 from the front reference line 94 is smaller than the bulging amount of the rear end top portion 92 from the rear reference line 95. The end surface 86A of the front half portion of the bulging portion 83 is inclined gently from the fold 77 toward front end top portion 88 so as to approach the front reference line 94. The end surface 86B of the rear half portion of the bulging portion 83 is provided to extend from the fold 77 toward the rear end top portion 92 in parallel to the rear reference line 95.

### Functions of Terminal

In a state in which the terminal 10 is assembled, the dielectric 20 is provided on an inner side of the small diameter portion 55 in the radial direction. The spring portion 59 is provided spaced apart from an outer circumferential surface of the dielectric 20 (see FIG. 5). The distance of the inclined portion 75 that is spaced apart from the outer circumferential surface of the dielectric 20 increases as it extends forward. The joining portion and the rear portion 82 are provided close to the outer circumferential surface of the dielectric 20.

When the terminal 10 is housed in the housing, the small diameter portion 55 of the second outer conductor 52 is provided in a protruding manner in a hood (not shown) of the housing. In this state, the connector is fitted into the mating connector, and as shown in FIG. 8, the mating outer conductor 212 of the mating terminal 210 is fitted to a radially outer side of the small diameter portion 55. As a result of the contact point 57 coming into contact with the mating outer conductor 212 that is inserted from the front, the spring portion 59 is elastically deformed radially inward about the fulcrum 72 (including the fold 77). Here, the leading end portion 76 is inclined radially inward toward the front, and thus the mating outer conductor 212 can come into contact with the contact point 57 without coming into contact with the leading end portion 76. A uniform contact force directed radially inward (toward the center) from the plurality of contact points 57 and the one fixed contact point 58 that are arranged spaced apart from each other in the circumferential direction is applied to the mating outer conductor 212.

In a state in which the connector is fitted to the mating connector, the contact points 57 that are in contact with the mating outer conductor 212 deform radially inward from their positions in a natural state before the contact points 57 come into contact with the mating outer conductor 212 so as to approach the outer circumferential surface of the dielectric 20. In this case as well, the bulging amount of the front end top portion 88 can be kept small, and thus the front end top portion 88 of each of the bulging portions 83 is not located on a radially outer side relative to the top of the contact point 57. Accordingly, it is possible to avoid a situation in which the mating outer conductor 212 comes into contact with the contact points 57, and it is therefore possible to suppress an increase in the connection resistance caused by an interference between the mating outer conductor 212 and the contact points 57. It is also possible to prevent damage or the like caused by an interference of the mating outer conductor 212 with the contact points 57.

As described above, the terminal 10 according to Embodiment 1 includes the outer conductor 50 as the tubular main body whose axis is oriented in the front-rear direction. The outer conductor 50 includes: the fulcrum 72; a spring portion 59 that extends in the front-rear direction and is elastically deformable about the fulcrum 72; the contact point 57 that has a shape that is formed by a portion of the spring portion 59 being bulged radially outward; the rear portion 82 that is located on an opposite side of the spring portion 59 in the front-rear direction at a position rearward of the fulcrum 72; and the bulging portion 83 that has a shape that is formed by a front-rear part being bulged radially outward, the front-rear part being a part that extends from the root portion 78 of the spring portion 59 on the fulcrum 72 side to the rear portion 82. The bulging portion 83 includes the end surface 86 at a leading end of the front-rear part in a bulging direction of the front-rear part. The end surface 86 includes: the front end top portion 88 that is located at a radially outermost position on the root portion 78 side; and the rear end top portion 92 that is located at a radially outermost position on the rear portion 82 side. As viewed in a cross section of the bulging portion 83 taken along the front-rear direction, the normal line H1 that connects the front end top portion 88 and the front reference line 94 that extends along a front adjacent part 87 that is adjacent to the bulging portion 83 in the root portion 78 is shorter in length than the normal line H2 that connects the rear end top portion 92 and the rear reference line 95 that extends along the rear adjacent part 91 that is adjacent to the bulging portion 83 in the rear portion 82.

With the configuration described above, the bulging amount of the front end top portion that bulges radially outward 88 can be kept small, and it is therefore possible to avoid a situation in which the front end top portion 88 comes into contact with the mating terminal 210 in a state in which the mating terminal 210 is fitted to a radially outer side of the outer conductor 50. Accordingly, it is possible to prevent an increase in the connection resistance, damage, and the like caused by an interference of the mating terminal 210 with the bulging portion 83, and it is therefore possible to ensure the connection stability when the terminal 10 is connected to the mating terminal 210. On the other hand, the bulging amount of the rear end top portion 92 that bulges radially outward can be increased, and it is therefore possible to adjust the spring reaction force of the spring portion 59 to a predetermined level.

In particular, in the case of Embodiment 1, in a state in which the contact point 57 is in contact with the mating terminal 210 that is fitted to a radially outer side of the outer conductor 50, the front end top portion 88 is spaced apart from the mating terminal 210. With this configuration, the front end top portion 88 does not come into contact with the mating terminal 210, and thus damage and the like caused by an interference of the mating terminal 210 with the bulging portion 83 does not occur. Accordingly, the connection stability can be more reliably ensured.

Also, a front end surface of the bulging portion 83 is configured as the front slope portion 89 that is inclined forward from the front end top portion 88 to the front adjacent part 87, and a rear end surface of the bulging portion 83 is configured as the rear slope portion 93 that is inclined rearward from the rear end top portion 92 to the rear adjacent part 91. The rear slope portion 93 is longer in an inclination direction than the front slope portion 89. With this configuration, the bulging amount of the front end top portion 88 can be sufficiently kept small, and thus the interference between the front end top portion 88 and the mating terminal 210 can be more likely to be avoided. Also, the rear end portion of the bulging portion 83 including the rear end top portion 92 and the rear slope portion 93 can be shaped with high accuracy.

Furthermore, the spring portion 59 includes: the fold 77 that extends circumferentially at an intermediate position of the bulging portion 83 in the front-rear direction; the inclined portion 75 that is located on a front side of front and rear sides of the fold 77 and inclined radially outward as it extends forward; and the horizontal portion 74 that is located on the rear side and arranged along the front-rear direction. With this configuration, the front end top portion 88 is located above the slope of the inclined portion 75, which makes it more likely that the front end top portion 88 comes into contact with the mating terminal 210. Accordingly, the bulging amount of the front end top portion 88 that bulges radially outward can be kept small, and the use of the configuration of Embodiment 1 that can avoid the interference between the front end top portion 88 and the mating terminal 210 provides significant benefits. Also, the bulging portion 83 is provided in a part that extends from the inclined portion 75 to the horizontal portion 74, and thus the function of reinforcing the spring portion 59 can be appropriately exhibited.

In the case of Embodiment 1, the terminal 10 includes: the inner conductor 11; the dielectric 20 that houses the inner conductor 11; and the outer conductor 50 that houses the dielectric 20. The outer conductor 50 is used as the main body. In the case of Embodiment 1, it is possible to avoid a situation in which the front end top portion 88 comes into contact with the mating outer conductor 212, and ensure the stability of the connection between the outer conductor 50 and the mating outer conductor 212. Accordingly, the terminal 10 can exhibit a predetermined shielding performance as the shield terminal.

### Other Embodiments of the Present Disclosure

Embodiment 1 disclosed herein is exemplary in all aspects, and thus should not be construed as limiting.

In the case of Embodiment 1 described above, a shield terminal that includes an inner conductor, a dielectric, and an outer conductor is used as the terminal. According to another embodiment, an ordinary integrally molded terminal obtained by subjecting a conductive metal plate to bending processing or the like may be used as the terminal.

In the case of Embodiment 1 described above, the root portion of the spring portion is configured to include an inclined portion that is inclined radially outward from the fold as it extends forward. However, according to another embodiment, the root portion of the spring portion may be shaped to extend straight along the front-rear direction toward the front. In the case of the root portion of the spring portion extending straight along the front-rear direction, the entire root portion may be configured of the horizontal portion by eliminating the fold.

In the case of Embodiment 1 described above, the spring portion is configured to include the fold at a position forward of the fulcrum. However, according to another embodiment, the fulcrum may be configured as the fold by providing the fold and the fulcrum at the same position in the front-rear direction.

From the foregoing, it will be appreciated that various exemplary embodiments of the present disclosure have been described herein for purposes of illustration, and that various modifications may be made without departing from the scope and spirit of the present disclosure. Accordingly, the various exemplary embodiments disclosed herein are not intended to be limiting, with the true scope and spirit being indicated by the following claims.

What is claimed is:

1. A terminal comprising:
a tubular main body whose axis is oriented in a front-rear direction,
wherein the main body includes:
a fulcrum;
a spring portion that extends in the front-rear direction and is elastically deformable about the fulcrum;
a contact point that has a shape that is formed by a portion of the spring portion being bulged radially outward;
a rear portion that is located on an opposite side of the spring portion in the front-rear direction at a position rearward of the fulcrum; and
a bulging portion that has a shape that is formed by a front-rear part being bulged radially outward, the front-rear part being a part that extends from a root portion of the spring portion on the fulcrum side to the rear portion, and
the bulging portion includes an end surface at a leading end of the front-rear part in a bulging direction of the front-rear part,
the end surface includes: a front end top portion that is located at a radially outermost position on the root portion side; and a rear end top portion that is located at a radially outermost position on the rear portion side, and
as viewed in a cross section of the bulging portion taken along the front-rear direction, a normal line that connects the front end top portion and a front reference line that extends along a front adjacent part that is adjacent to the bulging portion in the root portion is shorter in length than a normal line that connects the rear end top portion and a rear reference line that extends along a rear adjacent part that is adjacent to the bulging portion in the rear portion.

2. The terminal according to claim 1,
wherein, in a state in which the contact point is in contact with a mating terminal that is fitted to a radially outer side of the main body, the front end top portion is spaced apart from the mating terminal.

3. The terminal according to claim 1,
wherein a front end surface of the bulging portion is configured as a front slope portion that is inclined radially outward from the front adjacent part to the front end top portion,
a rear end surface of the bulging portion is configured as a rear slope portion that is inclined radially outward from the rear adjacent part to the rear end top portion, and
the rear slope portion is longer in an inclination direction than the front slope portion.

4. The terminal according to claim 1,
wherein the spring portion includes:
a fold that extends circumferentially at an intermediate position of the bulging portion in the front-rear direction;
an inclined portion that is located on a front side of front and rear sides of the fold and inclined radially outward as it extends forward; and
a horizontal portion that is located on the rear side and arranged along the front-rear direction.

5. The terminal according to claim 1, comprising:
an inner conductor;
a dielectric that houses the inner conductor; and
an outer conductor that houses the dielectric,
wherein the outer conductor is used as the main body.
